(19) United States
(12) Patent Application Publication
(10) Pub. No.: US 2004/0251293 A1
(43) Pub. Date: Dec. 16, 2004

(54) Paper holder, and paper cutting device

(76) Inventors: Toshiharu Hirai, Osaka (JP); Susumu Nishimoto, Osaka (JP)

Correspondence Address: RABIN & Berdo, PC, 1101 14TH STREET, NW, SUITE 500, WASHINGTON, DC, 20005, US

(21) Appl. No.: 10/493,394

(22) PCT Filed: Oct. 23, 2002
(86) PCT No.: PCT/JP02/11021

(30) Foreign Application Priority Data
Nov. 1, 2001 (JP) 2001373403
Feb. 12, 2002 (JP) 200244209
Sep. 17, 2002 (JP) 2002269896

(51) Int. Cl. B26F 3/02; B65H 35/10

(52) U.S. Cl. 225/46

(57) ABSTRACT

A toilet paper holder is constituted of a storage body (13) storing toilet paper (38) and a lid body (14) covering the storage body (13) in an openable/closable manner. A paper end (39) drawn out from the toilet paper (38) stored in a storage part (15) of the storage body (13) extends frontward between a press roller (25) mounted on the lid body (14) and a guide roller (24) mounted on the storage body (13) in a pressed state, and is taken out from between a front edge (41) of the lid body (14) and a front part (35) of a flap mechanism (17) mounted on the storage body (13). The front part (35), which is swingable, is urged to a front position. A cutting mechanism (16) coming into contact with the paper for dissolving the same is detachably mounted on the storage body (13) on a position under the guide roller (24).

### TECHNICAL FIELD

The present invention relates to a paper holder and a paper cutter, and more particularly, it relates to a paper holder and a paper cutter dissolving rolled paper such as toilet paper with water and cutting the same.

### BACKGROUND ART

A conventional toilet paper holder rotatably holds rolled toilet paper, and a cover having an end serving as a cutting blade covers the toilet paper. The cover is formed to be axially rotatable, so that the user sets the toilet paper in a moved state.

When using the toilet paper holder, the user returns the cover to the position covering the toilet paper and applies power to pull the toilet paper while pressing an end of the cover with one hand and drawing out the toilet paper with another hand for cutting the same along an end of the cover.

The user must use both hands in order to cut the toilet paper with the aforementioned conventional toilet paper holder, which cannot be regarded as handy for a physically handicapped person.

Further, it follows that the end of the cut toilet paper remains under the cover, and hence the toilet paper is hard to pinch when used next. Also when the user opens the cover to pinch the toilet paper, the end of the toilet paper, often adhering along the outer periphery of the toilet paper itself, is still hard to pinch.

Accordingly, an object of the present invention is to provide a paper holder and a paper cutter enabling the user to use only one hand and to easily pinch an end of paper.

### DISCLOSURE OF THE INVENTION

In order to attain the aforementioned object, a paper holder according to a first aspect of the present invention is a paper holder cutting rolled paper such as toilet paper by dissolving the same with liquid, comprising a storage part storing the paper, a flap mechanism, allowing paper drawn out from the stored rolled paper to pass through its front part, rotatable between a first position and a second position and urged to be located on the first position, a cutting mechanism set on a position separated from the front part toward the side for drawing out the paper by a constant distance to come into contact with part of the paper, changed in position when the passing paper moves the front part toward the second position, along its cross direction for dissolving the same and tension supply means supplying the drawn paper with tension enabling movement of the front part.

According to this structure, the front part of the flap mechanism moves to the second position when the user tries to approximate the drawn paper to the cutting mechanism, not to hinder this.

In a paper holder according to a second aspect of the present invention, the tension supply means is provided between the storage part and the flap mechanism, and includes a guide roller guiding the drawn paper and a press roller set in opposition to the guide roller for pressing the drawn paper passing between the same and the guide roller along with the guide roller in the inventive structure according to the first aspect.

According to this structure, the drawn paper receives resistance when passing between the guide roller and the press roller.

In a paper holder according to a third aspect of the present invention, the storage part, the flap mechanism and the cutting mechanism constitute a storage body, a lid body formed to cover the storage body to be axially openable/closable with respect to the storage body is provided, and the guide roller is mounted on the storage body while the press roller is mounted on the lid body in the inventive structure according to the second aspect.

According to this structure, the drawn paper is held between the guide roller and the press roller when the user stores the rolled paper in a state opening the lid body, draws out the paper onto the guide roller and thereafter closes the lid body.

In a paper holder according to a fourth aspect of the present invention, the lid body is regulated in movement in a direction to be closed with respect to the storage body, and a rotating shaft of the press roller is held by a vertical slot formed in a support section fixed to the lid body in the inventive structure according to the third aspect.

According to this structure, power applied to the paper is rendered constant due to the own weight of the press roller.

In a paper holder according to a fifth aspect of the present invention, the rolled paper is drawn out in a rotating state, and the tension supply means includes rotational resistance supply means supplying the rolled paper with rotational resistance in the inventive structure according to the first aspect.

According to this structure, tension is caused on the drawn paper when the user draws out the rolled paper.

In a paper holder according to a sixth aspect of the present invention, the rotational resistance supply means includes a cylindrical weight roller stored in a cylindrical paper core of the rolled paper and rotatably held in a partially contacting state in the inventive structure according to the fifth aspect.

According to this structure, resistance is caused on rotation of the paper core, i.e., rotation of the rolled paper.

A paper holder according to a seventh aspect of the present invention further comprises a support arm having an end rotatably mounted on the storage part, and the weight roller is rotatably mounted on another end of the support arm in the inventive structure according to the sixth aspect.

According to this structure, it follows that movement of the paper core is constrained by the weight roller, and rotational resistance of the paper is decided by the weight of the weight roller.

A paper cutter according to an eighth aspect of the present invention is a paper cutter cutting paper by dissolving the same with liquid, comprising a moving mechanism whose front part allowing the paper to pass therethrough is movable between a first position and a second position and urged to be located on the first position, a cutting mechanism set in a state separated from the moving mechanism for linearly coming into contact with the paper, changed in position when the passing paper moves the front part toward the second position, along its cross direction and dissolving the same and tension supply means supplying the passing paper with tension for supplying power for moving the front part to the second position.

According to this structure, the front part of the moving mechanism moves to the second position when the user tries to approximate the drawn paper to the cutting mechanism, not to hinder this.

As hereinabove described, in the paper holder according to the first aspect of the present invention, the front part of the flap mechanism moves to the second position when the user approximates the drawn paper to the cutting mechanism, whereby the user can easily cut the paper on a desired position. Tension caused on the paper disappears when the paper is cut, whereby the front part of the flap mechanism returns to the first position. Therefore, the end of the paper separates from the cutting mechanism due to the movement of the front part so that diffusion of penetration of liquid is prevented and the end is easy to pinch, whereby next paper is easy to drawn and handiness is improved.

In the paper holder according to the second aspect of the present invention, the drawn paper receives resistance when passing between the guide roller and the press roller, whereby the user can supply desired tension to the paper in a drawn state of the paper in addition to the inventive effect according to the first aspect.

In the paper holder according to the third aspect of the present invention, the drawn paper is held between the guide roller and the press roller by closing the lid body, whereby the user can easily set the rolled paper and the paper holder is immediately usable for improving handiness in addition to the inventive effect according to the second aspect.

In the paper holder according to the fourth aspect of the present invention, the power applied to the paper is rendered constant due to the own weight of the press roller, whereby stable tension is supplied to the paper also when power is applied to the lid body to improve reliability in use in addition to the effect of the invention according to the third aspect.

In the paper holder according to the fifth aspect of the present invention, the rolled paper rotates when the user draws out the paper and tension is caused on the drawn paper following this, whereby movement of the front part to the second position is simplified to attain handiness in addition to the inventive effect according to the first aspect.

In the paper holder according to the sixth aspect of the present invention, resistance is caused on rotation of the rolled paper due to the weight roller, whereby desired tension is caused on the drawn paper in addition to the inventive effect according to the fifth aspect.

In the paper holder according to the seventh aspect of the present invention, the rotating state of the paper is stabilized and tension on the drawn paper can be adjusted due to the weight of the weight roller, whereby the paper holder is handy in addition to the inventive effect according to the sixth aspect.

In the paper cutter according to the eighth aspect of the present invention, the front part of the moving mechanism moves when the user tries to approximate the paper to the cutting mechanism, not to hinder this, whereby the user can easily cut the paper on a desired position. Further, tension caused on the paper disappears when the paper is cut, whereby the front part of the moving mechanism returns to the first position. Therefore, the end of the paper separates from the cutting mechanism due to the movement of the front part so that diffusion of penetration of liquid is prevented and the end is easy to pinch, whereby next paper is easy to drawn and handiness is improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front elevational view showing the external shape of a toilet paper holder according to a first embodiment of the present invention.

FIG. 2 is a right side elevational view showing the external shape of the toilet paper holder shown in FIG. 1.

FIG. 3 is a sectional view taken along the line III-III shown in FIG. 1.

FIG. 4 is a sectional view taken along the line IV-IV in FIG. 1.

FIG. 5 is a sectional view, corresponding to the sectional view shown in FIG. 3, showing an exemplary used state.

FIG. 6 is a sectional view in a state closing a lid body from the state shown in FIG. 5.

FIG. 7 shows diagrams, showing a principal part of the sectional view shown in FIG. 6, illustrating change of the used state.

FIG. 8 is a diagram showing balance of power for illustrating a moving state of a flap mechanism shown in FIG. 7.

FIG. 9 is a sectional view showing a schematic shape of a toilet paper holder according to a second embodiment of the present invention.

FIG. 10 shows schematic sectional views illustrating change of a used state of the toilet paper holder shown in FIG. 9.

### BEST MODES FOR CARRYING OUT THE INVENTION

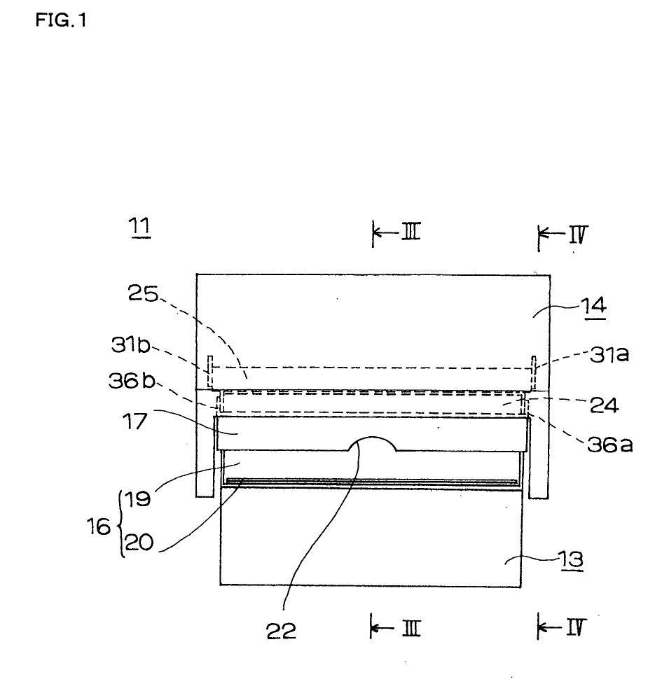

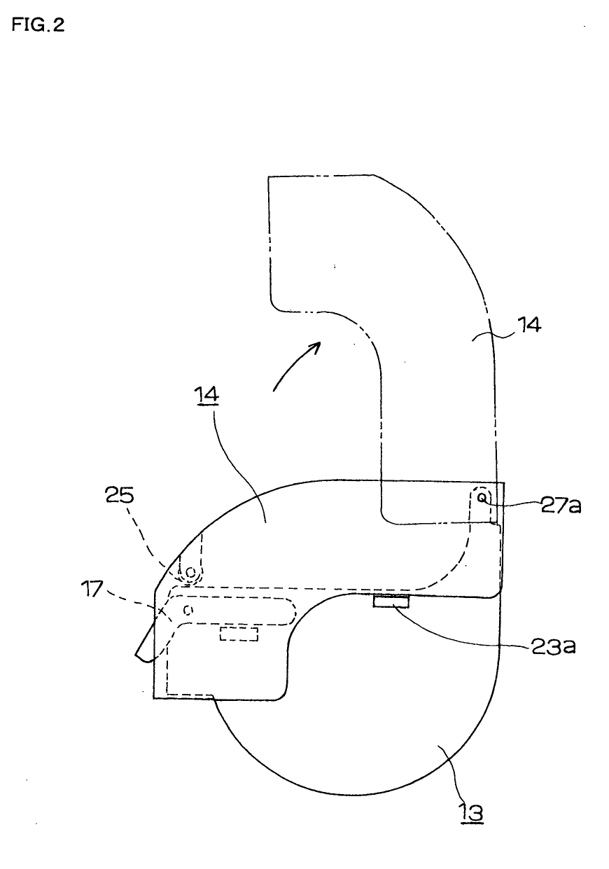

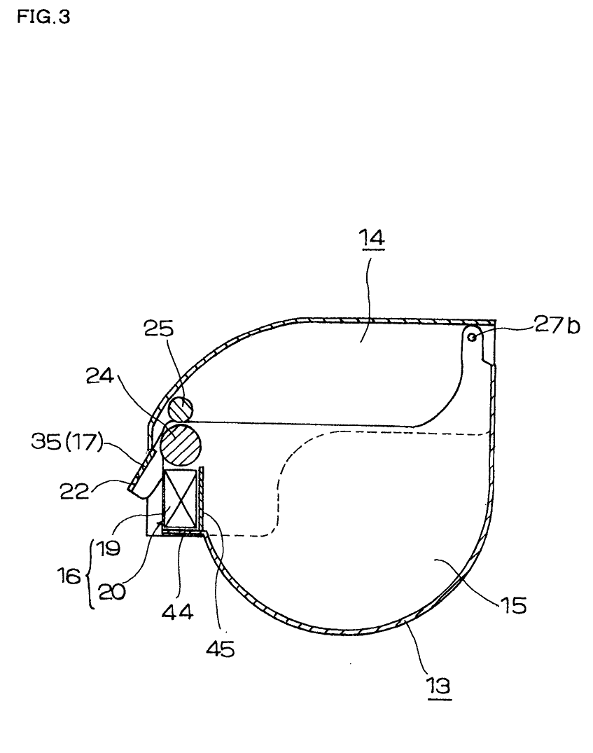

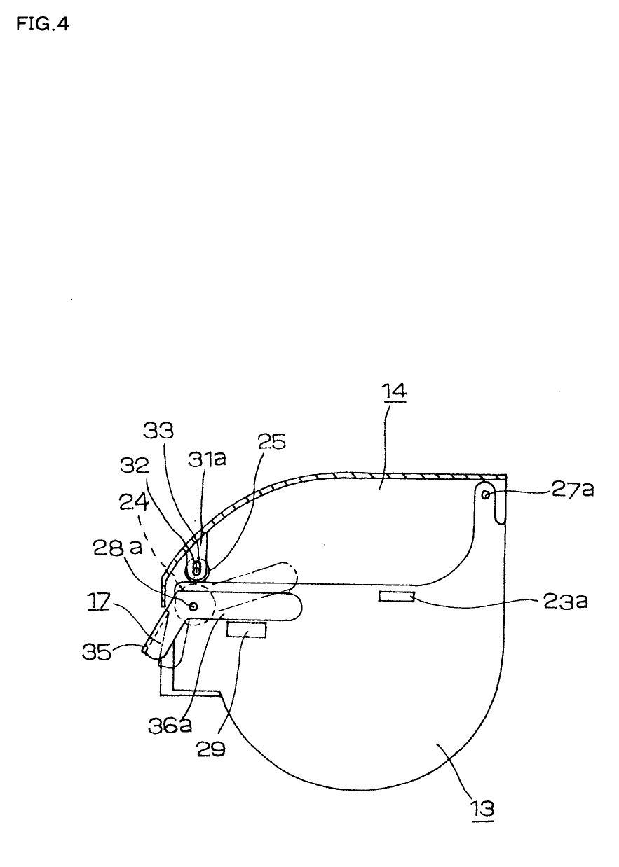

FIG. 1 is a front elevational view showing the external shape of a toilet paper holder according to a first embodiment of the present invention, FIG. 2 is a right side elevational view thereof, FIG. 3 is a sectional view taken along the line III-III shown in FIG. 1, and FIG. 4 is a sectional view taken along the line IV-IV shown in FIG. 1.

Referring to these figures, the toilet paper holder 11 is constituted of a cuplike storage body 13 storing toilet paper and a lid body 14 rotatably mounted through shafts 27a and 27b on the upper ends of the side walls of the storage body 13 for covering the storage body 13 in an openable/closable manner. Stoppers 23a and 23b are mounted on the side walls of the storage body 13 for inhibiting excess downward movement when the lid body 14 moves to cover the storage body 13.

A flap mechanism 17 rotatable about shafts 28a and 28b is mounted on a front portion of each of the side walls of the storage body 13, as shown in FIG. 4. The flap mechanism 17 is constituted of a front part 35 in the form of a rectangular flat plate and support parts 36a and 36b extending from both ends of the front part 35 in the form of boomerangs. The respective ones of the support parts 36a and 36b are mounted on the respective ones of both side surfaces of the storage body 13 to be rotatable about the shafts 28a and 28b.

The length of a portion of the support part 36a extending backward from the shaft 28a is rendered sufficiently larger than the length of a portion extending from the shaft 28a to a portion connected to the front part 35. Referring to FIG. 4, the support part 36a is formed to supply the flap mechanism 17 with a moment rotating clockwise about the shaft 28a. A stopper 29a is mounted on the right side surface of the storage body 13 under the backwardly extending portion of the support part 36a, for inhibiting the support part 36a from clockwise rotation on this position. In this state, the front part 35 of the flap mechanism 17 is set in a state exposed downward from the front end of the lid body 14 covering the storage body 13.

Thus, the flap mechanism 17 is rotatable between a first position shown by solid lines and a second position shown by two-dot chain lines as shown in FIG. 4. It follows that a rotation moment about the shafts 28a and 28b, resulting from the relation between the shape of the flap mechanism 17 and the rotation axis thereof, urges the flap mechanism 17 to be located on the first position in an ordinary state. The forward end of the front part 35 of the flap mechanism 17 is so positioned as to have a constant distance with respect to a tongue section 20 of the cutting mechanism 16 when moving to the second position of the two-dot chain lines shown in FIG. 4.

A guide roller 24 rotatable on the positions of the shafts 28a and 28b is mounted on inner sides of both side walls of the storage body 13. The guide roller 24 rotates separately from/independently of rotation of the flap mechanism 17 with respect to the shafts 28a and 28b. A press roller 25 rotatable about a shaft 32 is mounted on an upper position opposed to the guide roller 24. The shaft 32 of the press roller 25 is supported by support sections 31a and 31b fixed to the inner sides of the lid body 14.

The shaft 32 is held by a vertically extending slot 33 formed in the support section 31a. According to this structure, downward pressing force of the press roller 25 applied to the guide roller 24 is set by its own weight regularly to a constant value. This is because downward movement of the lid body 14 is regulated by the stoppers 23a and 23b and the press roller 25 is rendered vertically movable due to the shape of the slots 33 formed in the support sections 31a and 31b.

As shown in FIG. 3, the cutting mechanism 16 is detachably mounted on a space enclosed with the front end of the storage body 13 and a partition plate 45 uprightly provided on the back portion thereof. The cutting mechanism 16 is constituted of a tank 19 retaining water and the platelike tongue section 20 projecting from the lower portion of the tank 19 frontward. The tongue section 20, consisting of a porous substance in this embodiment, so functions that the water retained in the tank 19 through a sponge or the like penetrates through its forward end. An elliptic notch 22 is formed on the center of the front end of the front part 35 of the flap mechanism 17. Thus, drawing of the forward end of the toilet paper is further simplified as described later.

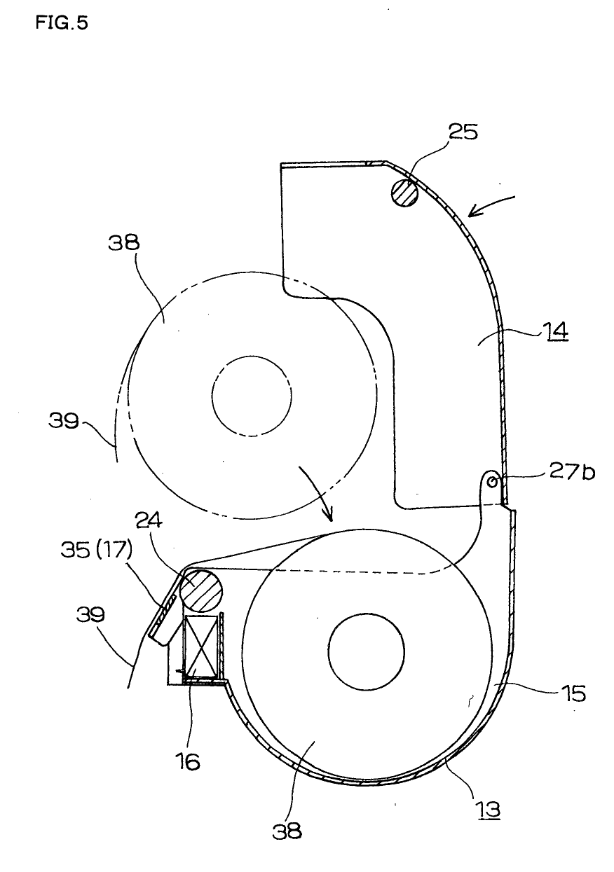

FIG. 5 is a sectional view, corresponding to the sectional view shown in FIG. 3, showing a state starting using the toilet paper holder.

Referring to the figure, the user rotates the lid body 14 and lifts the same upward from the state shown in FIG. 3 when using the toilet paper holder. Thus, the upper portion of the storage part 13 is opened. The user stores rolled toilet paper 38 in the storage body 13. At this time, the user may not support the central portion of the toilet paper 38 with a cylindrical support member or the like dissimilarly to a conventional toilet paper holder, but may simply store the toilet paper 38 in the storage body 13 as such.

The user sets a paper end 39 of the toilet paper 38 to hang the same from the upper portion of the guide roller 24 on the upper portion of the front part 35 of the flap mechanism 17. At this time, the user preferably sets the paper end 39 to be slightly downward beyond the end of the front part 35. The upper portion of the storage body 13 is opened and the press roller 25 set in opposition to the guide roller 24 is mounted on the lid body 14, whereby this setting is remarkably easy.

When completely storing the toilet paper 38 and setting the paper end 39, the user rotates the lid body 14 anticlockwise for moving the same to cover the upper portion of the storage body 13.

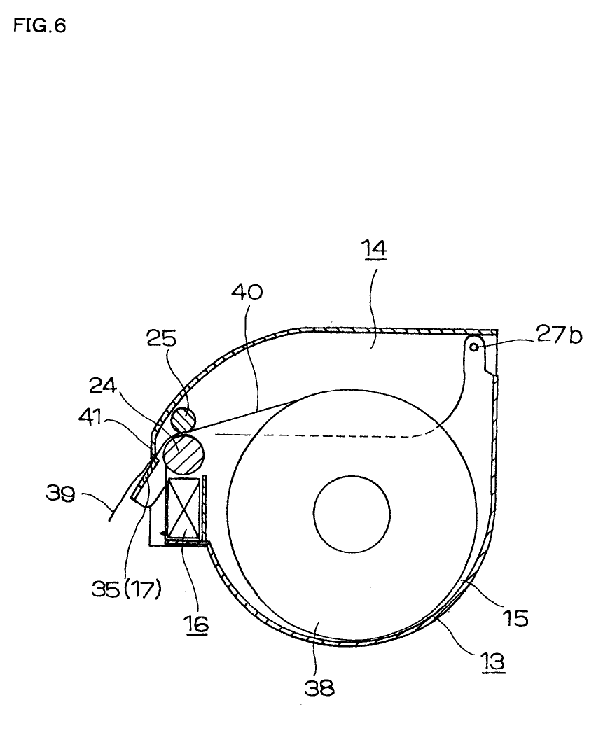

FIG. 6 is a sectional view showing a state completing return of the lid body 14 to the original position from the state of FIG. 5.

Referring to the figure, the paper end 39 drawn out from the toilet paper 38 is held between the guide roller 24 and the press roller 25 and passes through the front part 35 of the flap mechanism 17 from below a front edge 41 of the lid body 14 to be drawn out frontward, when the lid body 14 moves to the original position. In this state, a paper intermediate portion 40 of the toilet paper 38 is pressed between the press roller 25 and the guide roller 24 due to the own weight of the press roller 25. In this state shown in FIG. 6, preparation for starting using the toilet paper is completed so that the user can immediately use the same. In other words, the preparation is extremely easily completed with an operation of simply opening the lid body 14, introducing the toilet paper 38, drawing out its end and closing the lid body 14, whereby the toilet paper holder is handy.

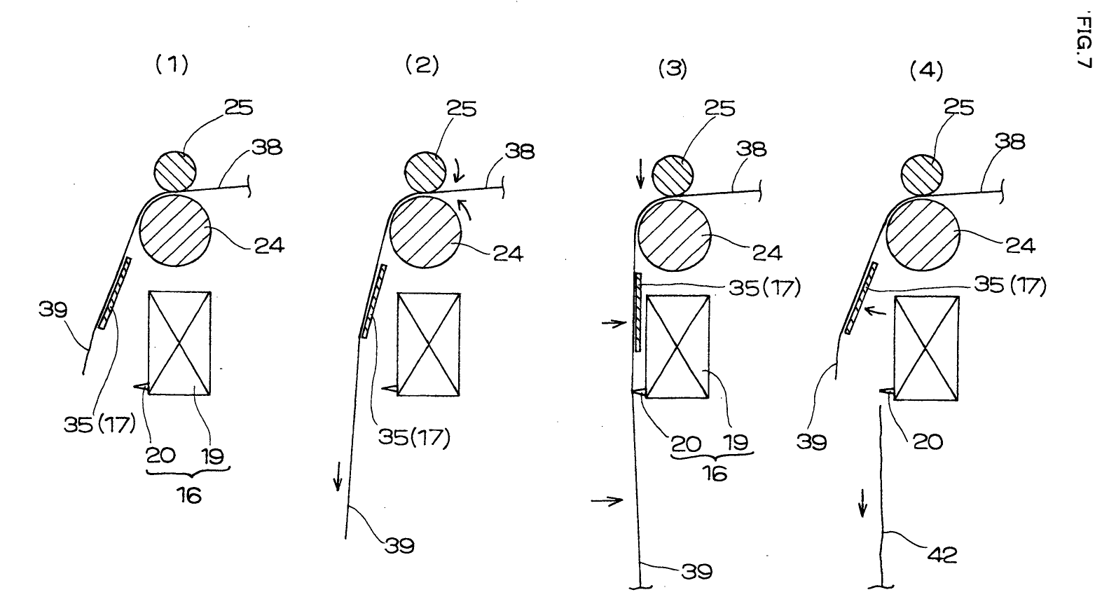

FIG. 7 shows diagrams showing a principal part in FIG. 6, for illustrating change of the used situation of the toilet paper holder 11.

(1) of FIG. 7 is a diagram corresponding to a set state of the toilet paper 38 shown in FIG. 6. In other words, the toilet paper 38 is drawn out frontward in the state pressed between the guide roller 24 and the press roller 25, and its paper end 39 passes through the front part 35 of the flap mechanism 17 and is in a state drawn out downward slightly longer than the lower end of the front part 35. At this time, the front part 35 of the flap mechanism 17 is located on the illustrated position (first position) due to urging by the rotation moment of the flap mechanism 17 as hereinabove described. In other words, the front part 35 is located frontward and upward with respect to the tongue section 20 of the cutting mechanism 35. Therefore, the paper end 39 of the toilet paper 38 does not come into contact with the tongue section 20 of the cutting mechanism 16 in this state.

From this state, the user pinches the paper end 39 and applies power to draw out the same downward, i.e., along arrow as shown in (2) of FIG. 7. While the paper end 39 is located slightly downward beyond the lower end of the front part 35, it is easy to pinch part of the paper end 39 even if the lower end of the paper end is aligned with the lowermost end of the front part 35, since the front pat 35 is formed with the notch 22. At this time, the guide roller 24 and the press roller 25 rotate along arrows respectively, whereby the user is enabled to smoothly draw out the toilet paper 38. After pinching the paper end 39 and drawing out the toilet paper 38 to a desired length, the user applies power to the paper end 39 along arrow and moves the paper intermediate portion 40 to come into contact with the tongue section 20 of the cutting mechanism 16, as shown in (3) of FIG. 7.

At this time, it follows that the toilet paper 38 is pressed between the press roller 25 and the guide roller 24 due to the own weight of the press roller 25, for supplying resistance against the drawing state of the paper intermediate portion 40 and causing constant tension. It follows that the front part 35 of the flap mechanism 17 changes from the state shown in (1) of FIG. 7 to the position (second portion) shown in (3) thereof due to this tension.

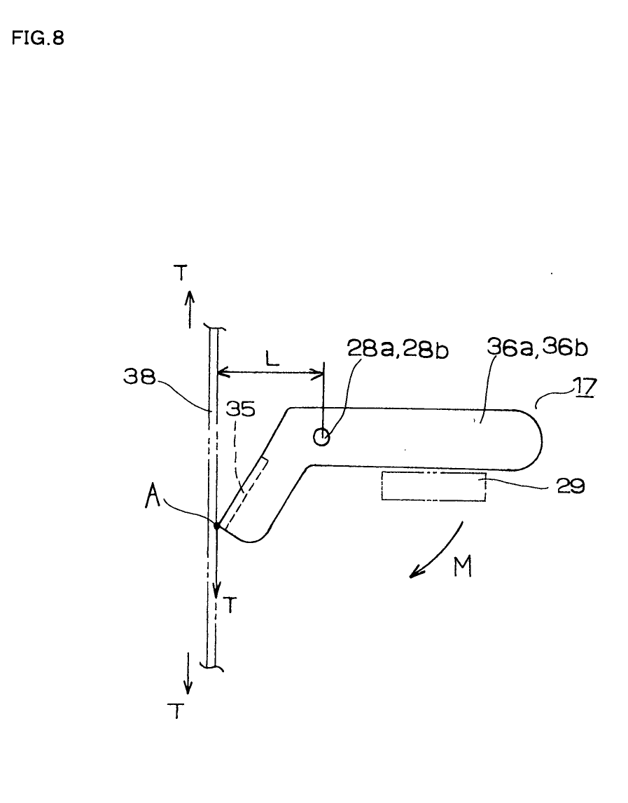

FIG. 8 shows balance of power applied to the flap mechanism 17 at this time.

Referring to the figure, it follows that tension T is caused on the toilet paper 38 due to resistance resulting from pressing between the guide roller 24 and the press roller 25 as hereinabove described. This tension T is set to be naturally smaller than the tensile strength of the toilet paper 38. It is assumed that a point “A” denotes a position where the lower end of the front part 35 of the flap mechanism 17 and the toilet paper 38 come into contact with each other at this time. Neglecting sliding of the toilet paper 38 with respect to the front part 35 at the point “A” in this case, it follows that the power of T is applied to the front part 35 downward at the point “A”. Assuming that L represents the vertical distance between the positions of the shafts 28a and 28b rendering the flap mechanism 17 rotatable and the toilet paper 38, it follows that an anticlockwise rotation moment M₁ is generated in the flap mechanism 17 due to the tension T applied to the toilet paper 38. In other words, the following expression holds:

M₁=T×L

On the other hand, the flap mechanism 17 is in a structure generating a specific clockwise rotation moment M. Therefore, when the user adjusts the magnitudes of these moments so that the following expression holds, it follows that the flap mechanism 17 rotates anticlockwise from the state shown in FIG. 8:

M₁>M

Thus, the front part 35 of the flap mechanism 17 moves to the state shown in (3) of FIG. 7. In other words, the press roller 25 and the guide roller 24 constitute tension supply means supplying the drawn toilet paper 38 with tension enabling movement of the front part 35.

The paper intermediate portion 40 of the toilet paper 38 is enabled to move toward the cutting mechanism 16 following this movement, to implement a state coming into contact with the tongue section 20 of the cutting mechanism 16. The length of the tongue section 20 in the cross direction, i.e., in the passing direction in the figure is set larger than the cross-directional length of the toilet paper 38. Therefore, it follows that a portion of the toilet paper 38 coming into contact with the forward end of the tongue section 20 supplied with water is entirely dissolved in the cross direction and cut.

(4) of FIG. 7 shows this state. When the portion coming into contact with the forward end of the tongue section 20 is dissolved and cut by the same, cut paper 42 downward beyond the same falls along arrow. On the other hand, the tension having been caused on the paper end 39 of the toilet paper 38 cut by the tongue section 20 disappears due to this cutting. Then, the anticlockwise rotation moment having been applied to the flap mechanism 17 disappears due to the disappearance of the tension T as obvious from FIG. 8, and the front part 35 moves to return to the original position due to the action of the clockwise rotation moment M specific to the flap mechanism 17.

When the front part 35 moves along arrow, the paper intermediate portion 40 of the toilet paper 38 having been along its front surface also moves to separate from the tongue section 20. Thus, the tongue section 20 stops supplying moisture to the lower end of the paper end 39, and there is no apprehension that the moisture further diffuses from the paper end 39 into the toilet paper 38. Since a constant distance is ensured between the lower end of the front part 35 and the tongue section 20, the paper end 39 is necessarily located downward beyond the end of the front part 35 after cutting. Therefore, it follows that the paper end 39 of the toilet paper 38 necessarily remains as a pinch margin in subsequent use after the cutting, and handiness is reliably ensured.

Thereafter the operations from (1) to (4) of FIG. 7 are repeated, and handiness continues.

The aforementioned embodiment, setting forth cutting of the toilet paper as a premise, is similarly applicable to a substance other than the toilet paper so far as the same is rolled paper dissolved with water. The substance may not be rolled but may be zonally supplied paper dissolvable with water.

The flap mechanism, urged by the rotation moment in the aforementioned embodiment, may alternatively be urged by another urging means such as a spring.

Further, the aforementioned embodiment, supplying tension to the toilet paper by pressing with the press roller, may alternatively be formed to supply tension by another method such as a method passing the toilet paper through a constant frictional surface.

In addition, the press roller, mounted on the lid body in the aforementioned embodiment, may alternatively be formed to be mounted on the storage body side.

Further, the aforementioned embodiment, regulating downward movement of the lid body and pivotally supporting the press roller with the slots, may alternatively be formed to eliminate regulation of the lid body and pivotally support the press roller with ordinary round holes.

Further, the aforementioned embodiment, cutting the toilet paper by dissolution with water, may use another liquid so far as the same can dissolve and cut the toilet paper. Dissolution is a concept including not only such dissolution that fibers constituting the paper are dissolved and decomposed by penetration of liquid to cause cutting but also such dissolution that bonding between fibers is lost due to penetration of liquid to cause cutting.

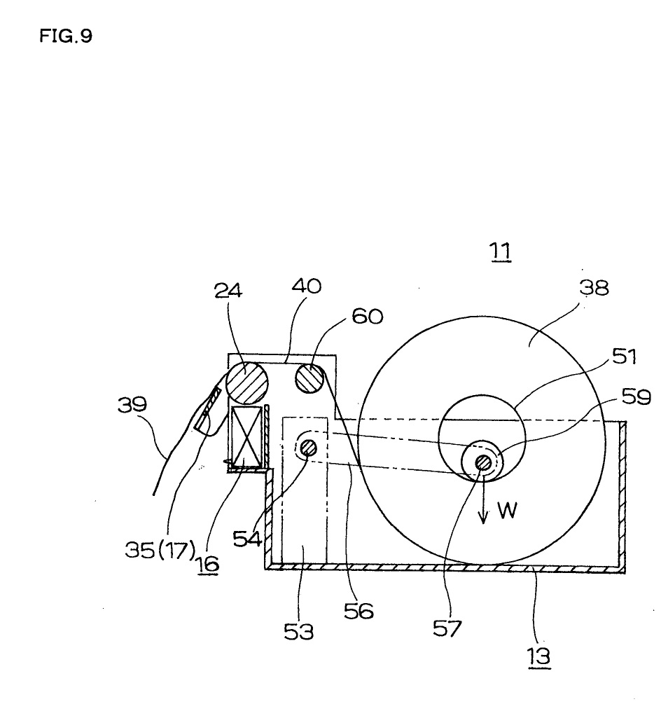

FIG. 9 is a diagram showing a schematic sectional shape of a toilet paper holder according to a second embodiment of the present invention.

The toilet paper holder according to this embodiment is remarkably different from that according to the aforementioned first embodiment in a point that no lid body is provided. Therefore, this embodiment is provided with no press roller supplying tension to drawn toilet paper.

Referring to FIG. 9, a toilet paper holder 11 is formed about a box-type storage body 13 having an open upper portion. A cutting mechanism 16 is detachably mounted in front of the storage body 13, i.e., on the left-side direction in the figure, and a guide roller 24 is mounted above the same. Further, a swingable flap mechanism 17 is mounted on the left side in this figure. The figure shows a front part 35 of the flap mechanism 17 as a section. Since the cutting mechanism 16, the guide roller 24 and the flap mechanism 17 are similar to those of the aforementioned embodiment and the principle of cutting of the toilet paper by dissolution is also similar, and hence redundant description is not repeated.

A support body 53 is fixed to the front side of the storage body 13, and a support arm 56 is mounted on the upper side of the support body 53 to be rotatable about a shaft 54. A cylindrical rotatable weight roller 59 is mounted on the other end of the support arm 56 through a shaft 57. The axial length of the weight roller 59 substantially corresponds to the axial length of toilet paper 38 stored in the storage body 13. A rotatable guide roller 60 extending over both side walls of the storage body 13 is mounted above the support body 53.

When using the toilet paper holder, the user rotates the support arm 56 anticlockwise about the shaft 54 from the state shown in FIG. 9 and lifts the same upward along with the weight roller 59. In a state moving the weight roller 59 upward beyond the upper ends of the side walls of the storage body 13, the user sets the toilet paper 38 to be stored in the storage body 13 for inserting the weight roller 59 into its paper core 51. In this state, the user moves the toilet paper 38 downward along with the support arm 56 and the weight roller 59, and sets the same so that its lower surface comes into contact with the upper surface of the storage body 13. Then, the user extends a paper end 39 drawn out from the toilet paper 38 over the upper surface of the guide roller 60 and the upper surface of another guide roller 24, and sets the same to pass through a portion above the front part 35 of the flap mechanism 17.

Then, the user pinches the paper end 39 and applies power to draw out the same downward. Then, it follows that the toilet paper 38 is drawn out while rotating clockwise. At this time, the paper core 51 of the toilet paper 38 also rotates clockwise integrally with the toilet paper 38. The weight roller 59 rotatable about the shaft 57 is set in the paper core 51 as hereinabove described, and the support arm 56 supporting the shaft 57 is rotatable about a shaft 54.

Therefore, the lower end of the weight roller 59 is regularly in a state coming into contact with the inner surface of the paper core 51. Therefore, the weight roller 59 also similarly rotates clockwise following the clockwise rotation of the paper core 51. At this time, it follows that the weight W of the weight roller 59 is applied along arrow. Thus, it follows that the toilet paper 38 is pressed against the upper surface of the storage body 13 with power obtained by adding the weight of the weight roller 59 to its own weight and rotates clockwise in this state. Therefore, it follows that the toilet paper 38 causes larger rotational resistance as compared with a state where no weight roller 59 is set.

It follows that tension is caused on the drawn paper when the user draws out the paper end 39 due to this rotational resistance of the toilet paper 38. It follows that this tension depends on the weight of the weight roller 59, whereby the user is enabled to properly adjust the tension of the paper necessary for moving the front part 35 of the flap mechanism 17 by adjusting the weight of the weight roller 59. In other words, it follows that the weight roller 59 constitutes tension supply means supplying the drawn paper with tension enabling movement of the front part 35 of the flap mechanism 17 and further constitutes rotational resistance means applying resistance to rotation of the toilet paper 38 in this embodiment.

This embodiment, mounting the weight roller 59 on the storage body 13 through the support body 53 and the support arm 56, can alternatively be so formed as to singly store the weight roller 59 in the paper core 51 of the toilet paper 38 in the object of supplying tension to the drawn paper.

In the paper holder according to this embodiment, setting of the toilet paper 38 is further simplified since no lid body is provided dissimilarly to the aforementioned embodiment while the decreasing state of the toilet paper 38 can be so easily confirmed that the paper holder is further handy.

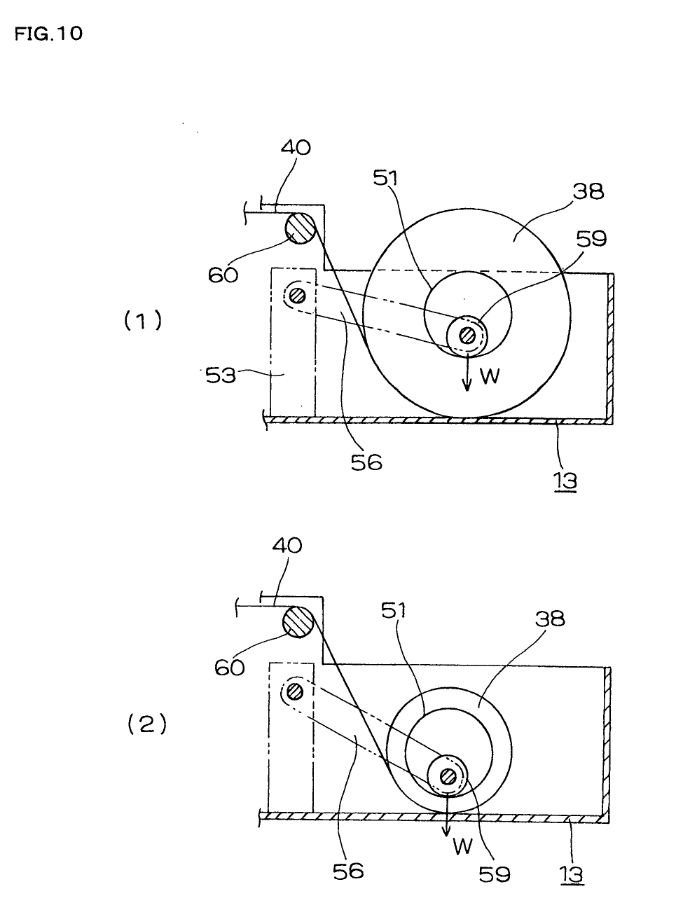

FIG. 10 shows schematic sectional views illustrating change of the used state of the paper holder according to the embodiment shown in FIG. 9.

Referring to the figure, (1) shows a state where the toilet paper 38 has slightly decreased as compared with the state shown in FIG. 9, and (2) shows a state where the toilet paper 38 has considerably decreased.

When the paper is drawn out from the toilet paper 38 and used, the outer diameter of the toilet paper 38 gradually decreases. It follows that the position of the paper core 51 gradually moves downward following this decrease. The weight roller 59 is rotatably mounted with respect to the support arm 56 and the support arm 56 is rotatably mounted with respect to the support body 53, whereby it follows that the support arm 56 and the weight roller 59 also move downward following the movement of the paper core 51. The weight roller 59 regularly rotatably comes into contact with the inner surface of the paper core 51 regardless of the residue of the toilet paper 38, whereby the weight W of the weight roller 59 is kept in the state regularly applied to the toilet paper 38 through the paper core 51. Thus, the state supplying the toilet paper 38 with at least constant rotational resistance with the weight W of the weight roller 59 is maintained also when the residue of the toilet paper 38 is considerably small as shown in (2) of FIG. 10. Thus, at least constant tension is regularly caused on the drawn paper regardless of its used state, whereby cutting by stable dissolution is enabled.

The aforementioned second embodiment, supplying the rotational resistance to the rolled paper with the weight roller, may alternatively employ another method applying constant frictional force to the paper for improving rotational resistance, for example.

The aforementioned embodiment, provided with no lid body dissimilarly to the first embodiment, may alternatively be formed to be provided with a lid body, as a matte of course.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL AVAILABILITY

As hereinabove described, the paper holder and the paper cutter according to the present invention are suitable for a device for enabling a physically handicapped person, who cannot use both hands, for example, to easily cut toilet paper.

1. A paper holder cutting rolled paper (38) such as toilet paper by dissolving the same with liquid, comprising:
a storage part (15) storing said paper;
a flap mechanism (17), allowing paper (39) drawn out from said stored rolled paper to pass through its front part (35), rotatable between a first position and a second position and urged to be located on said first position;
a cutting mechanism (16) set on a position separated from said front part toward the side for drawing out said paper by a constant distance to come into contact with part of said paper, changed in position when said passing paper moves said front part toward said second position, along its cross direction for dissolving the same; and
tension supply means (24, 25, 59) supplying said drawn paper with tension enabling movement of said front part.

2. The paper holder according to claim 1, wherein
said tension supply means is provided between said storage part and said flap mechanism, and includes:
a guide roller (24) guiding said drawn paper, and
a press roller (25) set in opposition to said guide roller for pressing said drawn paper passing between the same and said guide roller along with said guide roller.

3. The paper holder according to claim 2, wherein
said storage part, said flap mechanism and said cutting mechanism constitute a storage body (13),
a lid body (14) formed to cover said storage body to be axially openable/closable with respect to said storage body is provided, and
said guide roller is mounted on said storage body while said press roller is mounted on said lid body.

4. The paper holder according to claim 3, wherein
said lid body is regulated in movement in a direction to be closed with respect to said storage body, and
a rotating shaft (32) of said press roller is held by a vertical slot (33) formed in a support section (31) fixed to said lid body.

5. The paper holder according to claim 1, wherein
said rolled paper is drawn out in a rotating state, and
said tension supply means includes rotational resistance supply means (59) supplying said rolled paper with rotational resistance.

6. The paper holder according to claim 5, wherein
said rotational resistance supply means includes a cylindrical weight roller (59) stored in a cylindrical paper core of said rolled paper and rotatably held in a partially contacting state.

7. The paper holder according to claim 6, further comprising a support arm (56) having an end rotatably mounted on said storage part, wherein
said weight roller is rotatably mounted on another end of said support arm.

8. A paper cutter cutting paper (39) by dissolving the same with liquid, comprising:
a moving mechanism (17) whose front part (35) allowing said paper to pass therethrough is movable between a first position and a second position and urged to be located on said first position;
a cutting mechanism (16) set in a state separated from said moving mechanism for linearly coming into contact with said paper, changed in position when said passing paper moves said front part toward said second position, along its cross direction and dissolving the same, and tension supply means (24, 25, 59) supplying said passing paper with tension for supplying power for moving said front part to said second position.
